(19) United States
(12) Patent Application Publication
(10) Pub. No.: US 2012/0028854 A1
(43) Pub. Date: Feb. 2, 2012

(54) FLUID FOR DEEP OFFSHORE DRILLING

(75) Inventor: Samia Lamrani-Kern, Le Perreux Sur Marne (FR)

(73) Assignee: TOTAL RAFFINAGE MARKETING, Puteaux (FR)

(21) Appl. No.: 13/264,000

(22) PCT Filed: Apr. 14, 2010
(86) PCT No.: PCT/IB2010/051625

§ 371 Date: Oct. 12, 2011

(30) Foreign Application Priority Data
Apr. 15, 2009 (FR) FR09/01830

(51) Int. Cl. C09K 8/035; C09K 8/02

(52) U.S. Cl. 507/112; 507/103; 507/110

(57) ABSTRACT

The disclosure relates to a drilling fluid having a viscosity at 40° C. less than or equal to 2.5 mm²/s and having a vapor pressure at 100° C. less than or equal to 10 mBars (1 KPa) obtained from a hydrocarbon fraction having a distillation temperature of 200 to 280° C. and a naphthene hydrocarbon content of less than 40 wt % of the fraction.

### CROSS-REFERENCE TO RELATED APPLICATIONS

This application is a National Phase Entry of International Application No. PCT/IB2010/051625, filed on Apr. 14, 2010, which claims priority to French Patent Application Serial No. 0901830, filed on Apr. 15, 2009, both of which are incorporated by reference herein.

### BACKGROUND AND SUMMARY

The present invention relates to a drilling fluid particularly suitable for deep offshore (in deep-sea) drilling operations, that is to say drilling operations in temperature conditions at particularly difficult depths. Thus it is possible to operate at sea at great depths down to 5500 m, when the temperature gradient between the entrance to the well and the bottom of the well can reach 200° C., as the temperature at the entrance to the well can be close to polar temperatures and the temperature at the bottom of the well more than 160° C. The present invention also relates to the drilling mud comprising the said fluid, and the use of same.

Drilling fluids account for 30 to 95% by weight of the composition of drilling muds. These drilling muds play an essential part during onshore or offshore drilling operations, as they make it possible to lubricate the drilling tool (or rock bit) in order to limit its wear, but also to raise to the surface for treatment, the rock cuttings created during drilling and keep them in suspension during periods when circulation of the mud has been stopped and finally to ensure the maintenance of the pressure in the formation in order to avoid leaks and/or collapses of walls. The drilling mud is generally stored at the surface of the well in order that it can be pumped.

Drilling muds have very complex formulations depending on the nature of the formations passed through, the depth, the geometry, the pressure and temperature conditions, and other characteristics of the well. There are two main categories of drilling muds: water-based muds and oil-based muds. In water-based muds (WBM), the drilling fluid is water, and they are reserved for low-technology applications and onshore (on land) drilling operations, or offshore operations at very shallow depths (a few metres). In oil-based muds (OBM), the drilling fluid is a hydrocarbon fluid chosen from different compounds available on the market.

These drilling fluids are divided into 3 major categories:

Group I comprises drilling fluids with a high aromatic content containing from 5 to 30% monoaromatic and/or polyaromatic compounds resulting from the refining of crude oils, that is to say gas-oils and conventional mineral oils.

Group II comprises drilling fluids with a medium aromatic content resulting from the refining of crude oils and containing from 0.5 to 5% monoaromatic and/or polyaromatic compounds such as unconventional or weakly hydrotreated mineral oils often called LTMOs (low toxicity mineral oils).

Finally, Group III comprises drilling fluids with a low aromatic content, that is to say containing less than 0.5% total aromatics including less than 10 ppm of polyaromatic compounds. These fluids result from chemical syntheses, or severely hydrotreated, hydrocracked or hydroisomerized refined cuts. They can also be composed of synthetic paraffins resulting from the Fisher Tropsch process, polymerized olefins (internal olefins or IOs, linear alpha olefins or LAOs, and poly alpha olefins or PAOs), and esters. These Group III fluids are called synthetic in accordance with the OSPAR Protocol by Decision 2000/3 on the Use of Organic-Phase Drilling fluids (OPF) and the Discharge of OPF-Contaminated Cuttings.

These Group III fluids are preferred by operators not only for their thermal stability, their resistance to oxidation, their low toxicity linked to their low aromaticity and their non-irritant and environment-respecting character, but also for their observance of safety requirements, by having a high flash point and low volatility.

Indeed, hydrocarbon vapours of the drilling fluid in suspension in the ambient air can reach significant concentrations around recovering mud vibrating screens, and around points where the mud is stored and treated. Operators present for drilling operations can consequently come into contact with muds containing these fluids, either by skin contact or by inhalation. These personnel can thus be exposed to concentrations of vaporized hydrocarbon products exceeding 450 mg/m³. In Norway, the authorities (Norwegian Labour Inspection Authority 2003) limit the occupational exposure limit (OEL) to 50 mg/m³ of hydrocarbon vapours in the area around a drilling well. A substantial increase in the risk of lung cancer or fibrosis between 50 and 100 mg/m³ has been recorded.

Moreover, apart from the intrinsic volatility associated with the hydrocarbon nature and the composition of the fluid, the temperature of the mud at the exit from the well and its rate of circulation will influence the quantity of vapour in the working area and consequently the level of exposure of operators. Knowledge of the level of volatility of the drilling fluid is therefore essential if the effects on the health and the safety of operators are to be controlled. This volatility nevertheless remains difficult to quantify, in particular for hydrocarbon fluids of low volatility. However, this volatility criterion is important only when the mud returns to the surface, and the mud must above all have all the characteristics required in order that the rock bit at the bottom of the well does not wear too quickly or does not become blocked.

The main rheological properties of oil-based muds containing from 60% to 95% by weight of at least one drilling fluid, in particular in terms of viscosity under stress, depend essentially on those of the fluid. In the present case, a good low-temperature rheology between −10° C. and −20° C. means achieving a good viscosity at these temperatures while keeping the other characteristics equal.

In order to reach negative temperatures, below −10° C. in particular, it is often preferred to use light hydrocarbons having good low-temperature viscosity properties. However, such hydrocarbons have the drawback of also being very volatile, which increases the health and safety risks for users when the former are brought up to the well head, where the temperature of the mud reaches more than 60° C. Moreover, fluids with a very low viscosity are sought, for example having a kinematic viscosity at 40° C. of less than 2.5 mm²/s according to ISO 3104 or ASTM D445, in the case of deep drilling operations in order to limit the losses of energy due to friction, mainly at the drill pipe, with a view to reducing the drilling time.

In order to select drilling fluids, it is usual to measure their kinematic viscosities at 20° C. (Kv20° C.) and at 40° C. (Kv40° C.) according to ISO 3104 standard (or ASTM D445 standard). However, it is not enough to represent the rheological behaviour of the fluid as a function of the different temperatures to which it will be subjected. It is preferred to produce a rheological curve of the fluid corresponding to the changes in its kinematic viscosity between −20° C. and 100° C. by successive measurements according to ISO 3104 standard.

In order to compare the volatility of drilling fluids, these fluids can be differentiated on the basis of their flash points measured according to ASTM D 93 standard. However, this measurement is not enough to assess the effective volatility, in particular that of the mud at the exit from a well during drilling. Numerous methods have been proposed in attempting to quantify this volatility. In Europe, 7 methods have been listed and recognized by the HSPA (Hydrocarbon Solvent Producer Associations) for quantifying the volatility of hydrocarbon fluids. These methods are described in the document OECD Guidelines 104 of 7 Jul. 1995. These methods do not allow volatility to be determined using a single method over the whole of the possible range comprised between 10⁻⁴ and 10⁺⁵ Pa (0.1 to 1000 mbars). Moreover, to measure low vapour tensions, or pressures of less than 0.005 mbar at 20° C., the reproducibility intervals of the listed methods are too wide, which does not make it easy to easily distinguish between products, in particular for products with very low volatility.

To model these methods, the Americans and the Europeans have developed common volatility calculation tools taking into account the physico-chemical characteristics and the composition of the fluids. At present, two protocols have been proposed: VPtool, recommended in Europe by the HSPA (Hydrocarbon Solvent Producer Associations) described in the text OECD Guidelines 104 dated 27 Jul. 1995 available from the European authority, and EPIWINNT, recommended in the USA by the USEPA (US Environmental Protection Agency). These model-based calculation tools allow the vapour tension at 20° C. (or vapour pressure at 20° C.) of a fluid to be defined from the physico-chemical characteristics and the composition of the said fluid.

Among the oil-based mud fluids used in oil fields, aromatic diesel cuts resulting from straight-run distillations having distillation temperatures comprised between 250 and 380° C. have a viscosity at 40° C. determined according to ISO 3104 standard of the order of 3 mm²/s for a volatility at 100° C. of 10 mbars (1 KPa). These fluids are used less and less, as their toxicity is high because of their high aromatics content, greater than 10%, which makes them unsuitable for offshore drilling operations since this contravenes the environmental regulations of most countries.

Drilling fluids are also known based on weakly hydrotreated kerosine cuts present on the market and the viscosity of which varies from 1.7 to 1.9 mm²/s for a volatility of 20 to 25 mbars (2 to 2.5 KPa). Although the viscosity at 40° C. is good, these fluids are very volatile, which contravenes environmental and safety regulations. Drillers use, but less systematically, hydrocarbons which mostly comprise n-paraffins: their viscosity varies from 1.5 to 2 mm²/s, while their volatility remains above 11 mbars (1.1 KPa): their pour point close to 0° C. (ASTM D97), and their very high viscosity at low temperatures (kinematic viscosity at 0° C. more than 12 cSt according to ASTM D445) makes them unsuitable for deep offshore drilling.

Patent WO97/34963 recommends the use as drilling fluids of hydrocarbon cuts obtained by GTL, or gas to liquid, conversion of a synthesis gas, after hydrocracking and hydroisomerization of the product obtained. This document recommends the use of non-toxic, non-polluting and biodegradable drilling fluids, these fluids being composed of a mixture of C10 to C24 n-paraffins and isoparaffins, the ratio of isoparaffins to n-paraffins varying from 0.5:1 to approximately 9:1, the isoparaffins containing more than 50% by weight of monomethyl species relative to the total weight of the isoparaffins present in the mixture. However, although the viscosity characteristics at 40° C. are acceptable, there is no mention of the volatility of these cuts.

### BRIEF DESCRIPTION OF THE DRAWING

FIG. 1 is a graph of results.

### DETAILED DESCRIPTION

The purpose of the present invention is to provide here a drilling fluid presenting the best compromise in terms of viscosity and volatility. It relates in particular to the obtaining of a fluid the characteristics of which present the best compromise between a viscosity at 40° C. always less than 2.5 mm²/s and a volatility calculated according to the VPtool protocol characterized by a vapour pressure at 100° C. always less than 10 mbars (1 KPa).

A subject of the present invention is therefore a drilling fluid having a viscosity at 40° C. less than or equal to 2.5 mm²/s and a vapour pressure at 100° C. less than or equal to 10 mbars (KPa) obtained from a hydrocarbon cut having a distillation temperature comprised between 200 and 350° C. with a naphthenic hydrocarbons content of less than 40%, preferably less than 35%, by weight of the said cut, and preferably the pour point of which is below −20° C. according to ASTM D97 standard. Preferably, the fluid has a kinematic viscosity at 40° C. of less than 2.3 mm²/s.

In order to obtain the vapour pressure values, the applicant used a calculation model wholly correlated with the VPTool tool, having the advantage of calculating the vapour pressure of a hydrocarbon fluid between 0 and 200° C. from its physico-chemical characteristics and its composition. Apart from the fact that this fluid is a good compromise for balancing viscosity and vapour tension, it also has good solvent properties for the additives generally used in drilling muds, and above all a good low-temperature resistance, associated with a low pour point, but also a low toxicity associated with its very low aromatics content, a significant biodegradability, greater than 60% according to the protocol OECD 306 as well as excellent ecotoxicological properties (compatible with the OSPAR regulations).

Within the context of the present invention, this fluid comprises hydrocarbon cuts obtained by straight-run distillation of crude oils, the distilled products subsequently being hydrocracked and/or hydrotreated, or even hydrodewaxed. These fluids can optionally be used mixed with esters of vegetable oils in concentration ratios comprised between 10/90 and 90/10. By hydrotreatment is meant desulphurization and/or dearomatization, the degree of desulphurization and/or dearomatization possibly being very high.

Preferably, these fluids have an aromatics content of less than 500 ppm and a sulphur content of less than 50 ppm. Preferably, the aromatics content will be less than 100 ppm and the sulphur content less than 10 ppm.

This fluid is obtained from hydrocarbons of the group constituted by highly dearomatized and desulphurized jet fuels and kerosines having a pour point below −20° C. measured according to ASTM D97 standard. By jet fuels is meant mixtures of gasoline cuts having boiling temperatures comprised between 130 and 210° C. and kerosene cuts having boiling temperatures comprised between 180 and 260° C. measured according to ASTM D86. More particularly, the fluid according to the invention comprises more than 50% by weight of hydrocarbons containing from 12 to 24 carbon atoms, and preferably more than 70% of hydrocarbons containing from 16 to 22 carbon atoms.

These fluids are more than 25% composed of isoparaffins and less than 45% of n-paraffins and less than 500 ppm of aromatics. More particularly, fluids are chosen containing from 25 to 70% of isoparaffins and from 5 to 45% of n-paraffins and less than 100 ppm of aromatics. Typically, these fluids contain a naphthenes concentration comprised between 20 and 40% by weight, preferably between 25 and 35% by weight of the fluid. These fluids can be used on their own or in combination with fluids of the prior art if the final characteristics of the composed fluid comply with the characteristics of viscosity and calculated volatility, and pour point forming the subject of the invention.

Another subject of the invention is the use of this fluid in the production of drilling muds, oil-based muds and/or water-based muds. Preferably, the drilling mud will comprise more than 30% of the drilling fluid. It will be used in combination with functional additives depending on the type of application of the mud. One of the main functional additives of the mud or of the fluid is the weighting agent essentially constituted by barite. Other additives which can be used in combination are emulsifiers, wetting agents, viscosifiers, filtrate-reducing agents, particle agents for forming gravel filters, propping agents for keeping fractures open in hydraulic manner in underground formations, such as cellophane, scleroglucan, xanthan.

The compositions of these muds obtained from fluids according to the invention will vary depending on whether they are used as buffer fluid, as drilling mud or as fracturing fluid for underground formations. Preferably this drilling mud is constituted of from 30% to 95% by fluid and from 5% to 70% by functional additives of the said mud.

A third subject of the invention is the use of the mud containing 30 to 95% of the fluid according to the invention for drilling at sea at depths of more than 2000 m, preferably of more than 4000 m, for drilling wells likewise at more than 2000 m, preferably more than 4000 m, these wells being standard, horizontal or deviated wells. This mud can be used as buffer fluid, as drilling mud or as fracturing fluid for underground formations. To illustrate the invention, examples are given below which cannot, however, be seen as limiting the invention.

### EXAMPLE 1

The present example serves to compare the characteristics of the fluids according to the invention hereafter, designated Di, with those normally used, designated Ti. Table I below lists the technical characteristics of each of these fluids.

TABLE I

| | Flash | Pour | Aniline | T° C./no. | Iso- | N- | | |
|---|---|---|---|---|---|---|---|---|
| | point | point | point | of carbons | paraffins | paraffins | Naphthenes | Aromatics |
| Density | ° C. | ° C. | ° C. | (° C.) | % | % | % | % |
| T1 | 115 | −27 | 91 | 250-335 | 48% | 8% | 44% | <0.010% |
| | | | | (C14-C18) | | | | |
| T2 | 100 | −51 | 80 | 230-270 | 35% | 6% | 59% | <0.005% |
| | | | | (C13-C16) | | | | |
| T3 | 95 | −6 | 87 | 210-250 | <5% | 95.6% | <5% | <0.2% |
| | | | | (C11-C17) | | | | |
| T4 ** | 83 | −39 | 85 | 200-250 | 37% | 22% | 41% | <0.5% |
| | | | | (C10-C15) | | | | |
| T5 | 68 | −50 | 64 | 188-250 | 40% | <5% | 40% | 15% |
| | | | | (C11-C16) | | | | |
| T6 | 87 | −15 | <60 | (C9-C27) | | | | >20% |
| D1 | 100 | −27 | 79.3 | 230-262 | 25 | 42 | 33 | <0.005 |
| | | | | (C12-C16) | | | | |
| D2 | 100 | −30 | 87 | 225-325 | 63 | 9 | 28 | <0.010 |
| | | | | (C12-C20) | | | | |
| D3 * | 100 | −27 | 82 | 225-300 | 45 | 25 | 30 | <0.010 |
| | | | | (C12-C18) | | | | |

* D3 = 0.5 D1 + 0.5 D2
** T4 according to prior art WO97/34963

The comparative performances of the compounds according to the invention and of the products of the prior art are given in Table II below.

TABLE II

| | T1 | T2 | T3 | T4 | T5 | T6 | D1 | D2 | D3 |
|---|---|---|---|---|---|---|---|---|---|
| VP at 100° C. | 1.456 | 6.311 | 11.747 | 22.381 | 25.6 | 28.564 | 8.371 | 4.088 | 6.19 |
| (mbars) | | | | | | | | | |
| Kv40 (Cst) | 3.5 | 2.3 | 1.8 | 1.7 | 1.5 | 2.9 | 2.1 | 2.5 | 2.2 |
| Dens. (kg/m³) | 820 | 814 | 763 | 796 | 800 | 844 | 807 | 790 | 810 |

* Density measured at 15° C. according to EN ISO12185

The Vp values were calculated using VPTool tool at 100° C.

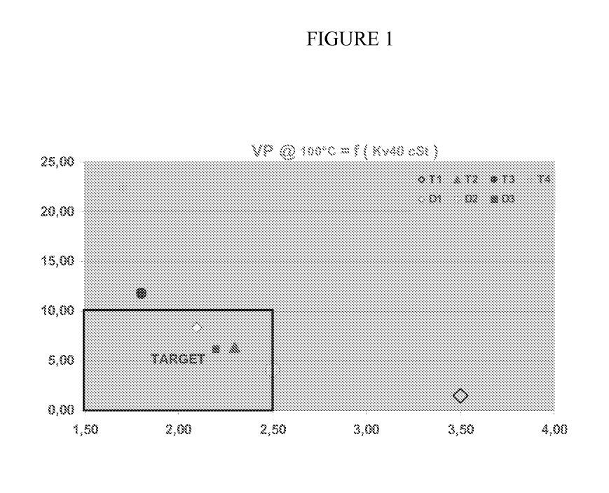

The results are compared with the help of the graph represented in FIG. 1. The best compromise is to have a KV40 at 40° C. of less than 2.5 Cst, and a calculated Vp at 100° C. of less than 10 mbars. Preferably the points in the intervals less than 2.3 Cst and less than 10 mbars are preferred. Compared with the products of the prior art, D1, D2 and D3 present the optimal characteristics in terms of volatility and viscosity while still having a low aromatics content.

1. Drilling fluid obtained from a hydrocarbon cut comprising a distillation temperature comprised between 200 and 350° C. with a naphthenic hydrocarbons content of less than 40%, by weight of the cut, the viscosity of which at 40° C. is less than or equal to 2.5 mm²/s, and a vapour pressure at 100° C. less than or equal to 10 mbars (1KPa).

2. Fluid according to claim 1, wherein its kinematic viscosity at 40° C. is less than 2.3 mm²/s.

3. Fluid according to claim 1, wherein it comprises hydrocarbon cuts obtained by hydrocracking and/or hydrotreating or hydrodewaxing of cuts resulting from the straight-run distillation of crude oils, optionally mixed with esters of vegetable oils.

4. Fluid according to claim 1, wherein the aromatics content is less than 500 ppm and its sulphur content is less than 50 ppm.

5. Fluid according to claim 1, wherein it is obtained from hydrocarbons of the group constituted by highly dearomatized and desulphurized jet fuels and kerosines having a pour point below −20° C. measured according to standard ASTM D97.

6. Fluid according to claim 1, wherein it comprises more than 50% by weight of hydrocarbons having from 12 to 24 carbon atoms.

7. Fluid according to claim 1, wherein it contains more than 25% by weight of isoparaffins and less than 45% by weight of n-paraffins and less than 500 ppm of aromatics for a naphthenes concentration of less than 35% by weight.

8. Fluid according to claim 1, wherein it contains from 25 to 70% of isoparaffins and from 5 to 45% of n-paraffins and less than 100 ppm of aromatics.

9. Drilling mud comprising more than 30% of drilling fluid in combination with functional additives, the drilling fluid being obtained from a hydrocarbon cut comprising a distillation temperature between 200 and 350° C. with a naphthenic hydrocarbons content of less than 40%-by weight of the cut, the viscosity of which at 40° C. is less than or equal to 2.5 mm²/s, and a vapour pressure at 100° C. less than or equal to 10 mbars (1KPa).

10. Mud according to claim 9, wherein it comprises from 30 to 95% of fluid and from 5 to 70% of functional additives chosen from the group consisting weighting agents, emulsifiers, wetting agents, viscosifiers, filtrate-reducing agents, particle agents for forming gravel filters, propping agents for keeping fractures open in hydraulic manner in underground formations, such as cellophane, scleroglucan, xanthan.

11. Use of the mud according to claim 9 for drilling, in particular drilling at sea, these wells being standard, horizontal or deviated wells.

12. Fluid according to claim 1, having a pour point below −20° C.

13. Fluid according to claim 1, wherein the hydrocarbon cut has a naphthenic hydrocarbons content of less than 35%, by weight of the cut.

14. Fluid according to claim 6, wherein it comprises more than 70% of hydrocarbons having from 16 to 22 carbon atoms.

15. Use of the mud according to claim 9 for drilling, in particular drilling at sea at depths of more than 2000 m for drilling wells likewise at more than 2000 m these wells being standard, horizontal or deviated wells.

16. Use of the mud according to claim 9 for drilling, in particular drilling at sea at depths of more than 4000 m for drilling wells likewise at more than 4000 m these wells being standard, horizontal or deviated wells.

17. Fluid according to claim 12, wherein its kinematic viscosity at 40° C. is less than 2.3 mm²/s.

18. Fluid according to claim 12, wherein it comprises hydrocarbon cuts obtained by hydrocracking and/or hydrotreating or hydrodewaxing of cuts resulting from the straight-run distillation of crude oils, optionally mixed with esters of vegetable oils.

19. Fluid according to claim 12, wherein the aromatics content is less than 500 ppm and its sulphur content is less than 50 ppm.

20. Fluid according to claim 12 obtained from hydrocarbons of the group constituted by highly dearomatized and desulphurized jet fuels and kerosines having a pour point below −20° C. measured according to standard ASTM D97.

21. Fluid according to claim 12, wherein it comprises more than 50% by weight of hydrocarbons having from 12 to 24 carbon atoms.

22. Fluid according to claim 12, wherein it contains more than 25% by weight of isoparaffins and less than 45% by weight of n-paraffins and less than 500 ppm of aromatics for a naphthenes concentration of less than 35% by weight.

23. Drilling mud comprising more than 30% of the drilling fluid according to claim 12 in combination with functional additives.

24. Mud according to claim 23, wherein it comprises from 30 to 95% of fluid and from 5 to 70% of functional additives chosen from the group consisting of weighting agents, emulsifiers, wetting agents, viscosifiers, filtrate-reducing agents, particle agents for forming gravel filters, propping agents for keeping fractures open in hydraulic manner in underground formations, such as cellophane, scleroglucan, or xanthan.

25. Use of the mud according to claim 23 for drilling, in particular drilling at sea for drilling wells, these wells being standard, horizontal or deviated wells.
